(19) United States
(12) Patent Application Publication
(10) Pub. No.: US 2010/0208078 A1
(43) Pub. Date: Aug. 19, 2010

(54) HORIZONTAL GAZE ESTIMATION FOR VIDEO CONFERENCING

(75) Inventors: Dihong Tian, San Jose, CA (US); Joseph T. Friel, Ardmore, PA (US); J. William Mauchly, Berwyn, PA (US)

Correspondence Address: EDELL, SHAPIRO & FINNAN, LLC, 1901 RESEARCH BOULEVARD, SUITE 400, ROCKVILLE, MD, 20850, US

(73) Assignee: Cisco Technology, Inc., San Jose, CA (US)

(21) Appl. No.: 12/372,221

(22) Filed: Feb. 17, 2009

(51) Int. Cl. H04N 5/225; G06K 9/00

(52) U.S. Cl. 348/169; 382/103; 348/E05.024; 348/14.08

(57) ABSTRACT

Techniques are provided to determine the horizontal gaze of a person from a video signal generated from viewing the person with at least one video camera. From the video signal, a head region of the person is detected and tracked. The dimensions and location of a sub-region within the head region is also detected and tracked from the video signal. An estimate of the horizontal gaze of the person is computed from a relative position of the sub-region within the head region.

### TECHNICAL FIELD

The present disclosure relates to video conferencing and more particularly to determining a horizontal gaze of a person involved in a video conferencing session.

### BACKGROUND

Face detection in video conferencing systems has many applications. For example, perceptual quality of decoded video under a given bit-rate budget can be improved by giving preference to face regions in the video coding process. However, face detection techniques alone do not provide any indication as to the horizontal gaze of a person. The horizontal gaze of a person can be used to determine “who is looking at whom” during a video conferencing session.

Gaze estimation techniques heretofore known were generally developed to aid human-computer interaction. As a result, they commonly rely on accurate eye tracking, either using special and extensive hardware to track optical phenomena of eyes or involving computer vision techniques to map eyes with an abstracted model. Performance of eye mapping techniques is generally poor due to the difficulty of accurate eyeball location and tracking detection and the computation complexity those processes require.

Accordingly, techniques are desired for estimating in real-time the horizontal gaze of a person or persons involved in a video conference session.

### BRIEF DESCRIPTION OF THE DRAWINGS

FIG. 1 is a diagram illustrating a multiple person telepresence video conferencing system configuration in which a horizontal gaze of a participating person is derived in order to determine at whom that person is looking.

FIGS. 2 and 3 are diagrams showing examples of an ear-nose-mouth (ENM) sub-region within a head region from which the horizontal gaze is estimated.

FIG. 4 is a diagram generally showing the dimensions and location of the ENM sub-region within the head region for which detection and tracking is made and from which the horizontal gaze is estimated.

FIG. 5 is a block diagram of a telepresence video conferencing system that is configured to determine the horizontal gaze of a person.

FIG. 6 is a block diagram of a controller that is configured to estimate the horizontal gaze of a person.

FIG. 7 is an example of a flow chart depicting logic for a horizontal gaze estimation process.

FIG. 8 is an example of a flow chart depicting logic for a process to compute the dimensions and location of the ENM sub-region within the head region.

### DESCRIPTION OF EXAMPLE EMBODIMENTS

### Overview

Techniques are described herein to determine the horizontal gaze of a person from a video signal generated from viewing the person with at least one video camera. From the video signal, a head region of the person is detected and tracked. The dimension and location of a sub-region within the head region is also detected and tracked from the video signal. An estimate of the horizontal gaze of the person is computed from a relative position of the sub-region within the head region.

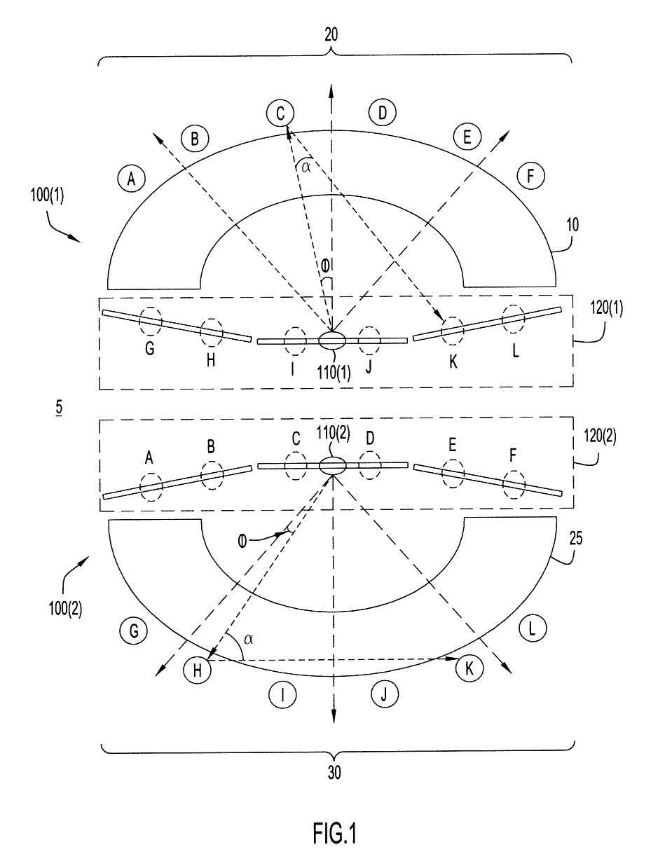

Referring first to FIG. 1, a telepresence video conferencing system is generally shown at reference numeral 5. A “telepresence” system is a high-fidelity video (with audio) conferencing system between system endpoints. Thus, the system 5 comprises at least first and second endpoints 100(1) and 100(2) where one or more persons may participate in a telepresence session. For example, at endpoint 100(1), there are positions around a table 10 for a group 20 of persons that are individually denoted A, B, C, D, E and F. Likewise, at endpoint 100(2), there are positions around a table 25 for a group 30 of persons that are individually denoted G, H, I, J, K and L.

Endpoint 100(1) comprises a video camera cluster shown at 110(1) and a display 120(1) comprised of multiple display panels (segments or sections) configured to display the image of a corresponding person. Endpoint 100(2) comprises a similarly configured video camera cluster 110(2) and a display 120(2). Each video camera cluster 110(1) and 110(2) may comprise one or more video cameras. Video camera cluster 110(1) is configured to capture into one video signal or several individual video signals each of the participating persons A-E in group 20 at endpoint 100(1), and video camera cluster 110(2) is configured to capture into one video signal or several individual video signals each of the participating persons G-L in group 30 at endpoint 100(2). For example, there may be a separate video camera (in each video camera cluster) directed to a corresponding person position around a table. Not shown for reasons of simplicity in FIG. 1 is the provision of microphones appropriately positioned in order to capture audio of the persons at each endpoint.

As indicated above, the display 120(1) comprises multiple display sections or panels configured to display in separate display sections a video image of a corresponding person, and more particularly, a video image of a corresponding person in group 30 at endpoint 100(2). Thus, display 120(1) comprises individual display sections to display corresponding video images of persons G-L (shown in phantom), derived from the video signal output generated by video camera cluster 110(2) at endpoint 100(2). Similarly, display 120(2) comprises individual display sections to display corresponding video images of persons A-G (shown in phantom), derived from the video signal output generated by video camera cluster 110(1) at endpoint 100(1).

Moreover, FIG. 1 shows an example where person K in group 30 is talking at a given point in time. It is desirable to compute an estimate of the horizontal gaze of other persons in groups 20 and 30 during the time when person K is talking. For example, it may be desirable to determine whether person C in group 20 is looking at person K and it may be desirable to determine whether person H in group 30 is looking at person K. The horizontal gaze problem is addressed by estimating the horizontal gaze of the detected face or head region of a person, which in turn is estimated by measuring the dimensions and relative position of a closely tracked eyes, nose and mouth (ENM) sub-region within the head region.

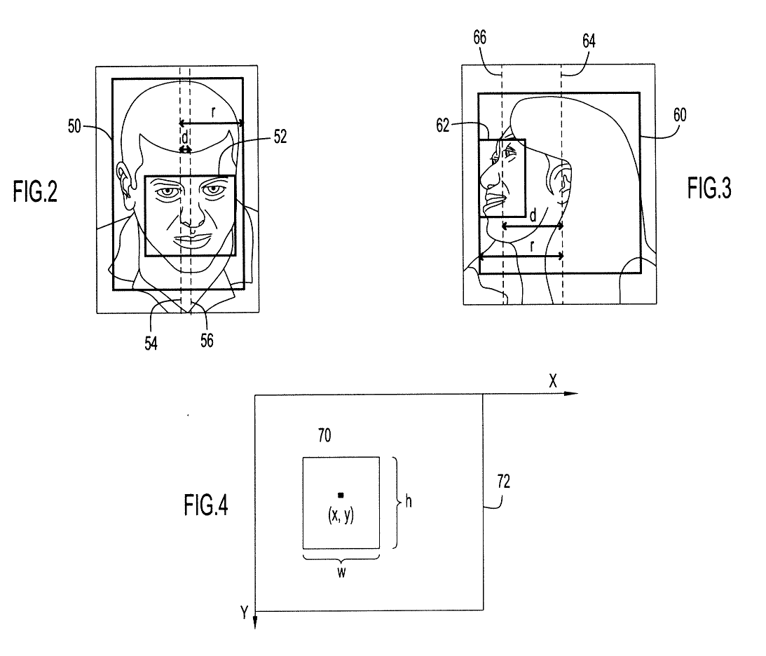

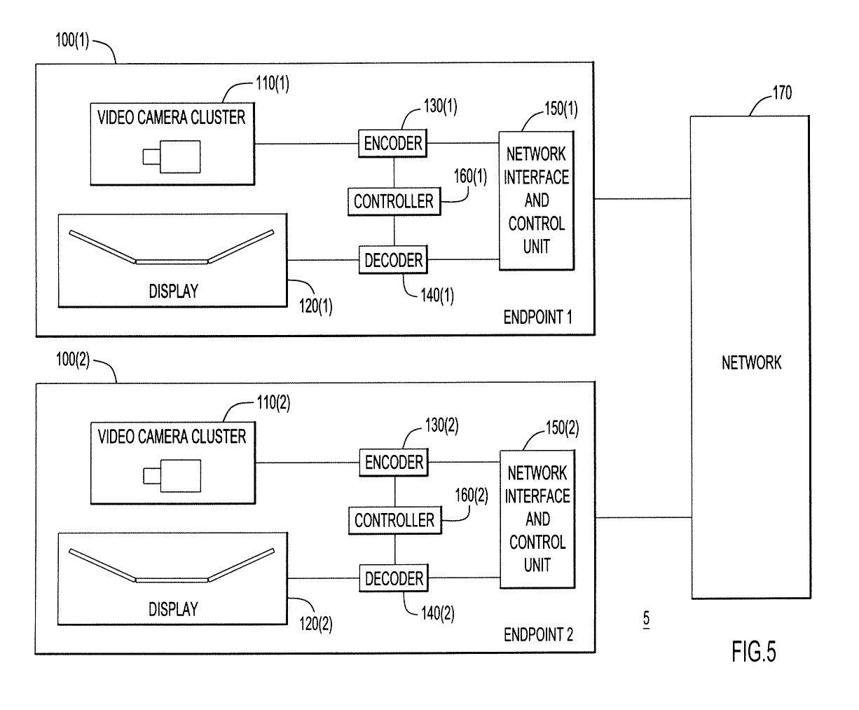

FIGS. 2 and 3 show two examples of the detected head region and ENM region. In FIG. 2, the head of a person is shown facing the video camera. The head region is delineated by a first outer (head) rectangle 50 and the ENM sub-region is denoted by a second inner ENM rectangle 52. By contrast, FIG. 3 shows an example where the head of the person is more of a profile with respect to the video camera. In FIG. 3, the head region is denoted by a first outer head rectangle 60 and the ENM sub-region is denoted by a second inner ENM rectangle 62.

The head rectangle and the ENM rectangle each have a horizontal center point. In FIG. 2, the horizontal line 54 passes through the horizontal center point of the head rectangle 50 and the horizontal line 56 passes through the horizontal center point of the ENM rectangle 52. In FIG. 3, the horizontal line 64 denotes passes through the horizontal center point of the head rectangle 60 and the horizontal line 66 passes through the horizontal center point of the ENM rectangle 62.

A measurement distance d is defined as the distance between the horizontal centers of the head rectangle and the ENM rectangle within it. Another measurement r is defined as a “radius” (½ the horizontal side length) of the head rectangle. Contrasting FIGS. 2 and 3, it is notable that the dimensions of the ENM rectangle 62 in FIG. 2 are less than the dimensions of the ENM rectangle 52 in FIG. 3. Moreover, the measurement distance d in the example of FIG. 2 is smaller than that for the example of FIG. 3.

Referring again to FIG. 1, with continued reference to FIGS. 2 and 3, the horizontal gaze of the face of a person with respect to the video camera can be represented by the angle α (alpha) shown in FIG. 1, and is estimated by the computation:

α=arcsin(d/r) (1)

where d are defined as explained above.

The actual viewing angle in FIG. 1 is (α+θ) at endpoint 100(1) and is (α−θ) at endpoint 100(2), where θ denotes the angle between an imaginary line that extends between the video camera and the face of a person and the video camera's optical axis. The angle θ may be calculated given the face positions of the person whose horizontal gaze is to be estimated. Thus, at endpoint 100(1), the angles θ and α are shown with respect to person C in group 20 and at endpoint 100(2), the angles θ and α are shown with respect to person H in group 30. As explained hereinafter, the estimated horizontal gaze angle α is combined with face positions on the display sections derived from video signals received from the other endpoint, together with other system parameters, such as the displacement of the display sections, to determine “who is looking at whom” during a telepresence session.

Reference is now made to FIG. 4. The challenge remaining is to detect and track the dimensions and location of an ENM sub-region (e.g., rectangle) 70, represented by (x, y, w, h), within a detected head region 72, where (x, y) is the center of the ENM sub-region 70 with respect to the upper left corner of the head rectangle 72 and w and h are the width and height, respectively, of the ENM sub-region 70. There are many ways to detect and track the ENM sub-region within the head region. One technique described herein employs probabilistic tracking, and particularly, Monte Carlo methods, also known as particle filter techniques.

Turning now to FIG. 5, a more detailed block diagram is provided to show the components of the endpoint devices 100(1) and 100(2). In the example shown in FIG. 5, the endpoint devices 100(1) and 100(2) are essentially identical, but this is not required. There could be variations between the equipment at each of the endpoints.

Each endpoint 100(1) and 100(2) can simultaneously serve as both a source and a destination of a video stream (containing video and audio information). Endpoint 100(1) comprises the video camera cluster 110(1), the display 120(1), an encoder 130(1), a decoder 140(1), a network interface and control unit 150(1) and a controller 160(1). Similarly, endpoint 100(2) comprises the video camera cluster 110(2), the display 120(2), an encoder 130(2), a decoder 140(2), a network interface and control unit 150(2) and a controller 160(2). Since the endpoints are the same, the operation of only endpoint 100(1) is now briefly described.

The video camera cluster 110(1) captures video of one or more persons and supplies video signals to the encoder 130(1). The encoder 130(1) encodes the video signals into packets for further processing by the network interface and control unit 150(1) that transmits the packets to the other endpoint device via the network 170. The network 170 may consist of a local area network and a wide area network, e.g., the Internet. The network interface and control unit 150(1) also receives packets sent from endpoint 100(2) and supplies them to the decoder 140(1). The decoder 140(1) decodes the packets into a format for display of picture information on the display 120(1). Audio is also captured by one or more microphones (not shown) and encoded into the stream of packets passed between endpoint devices. The controller 160(1) is configured to perform horizontal gaze analysis of the video signals produced by the video camera cluster 110(1) and from the decoded video signals that are derived from video captured by video camera cluster 110(2) and received from the endpoint 100(2). Likewise, the controller 160(2) at endpoint 100(2) is configured to perform horizontal gaze analysis of the video signals produced by the video camera cluster 110(2) and from the decoded video signals that are derived from video captured by video camera cluster 110(1) and received from the endpoint 100(1).

While FIG. 5 shows two endpoint devices 100(1) and 100(2), it should be understood that there may be more than two endpoint devices participating in a telepresence session. The horizontal gaze analysis techniques described herein are applicable to use during a session where there are two or more participating endpoint devices.

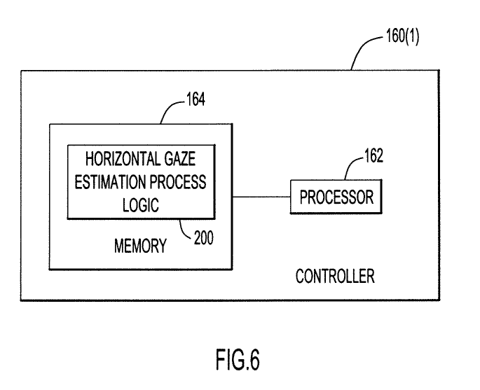

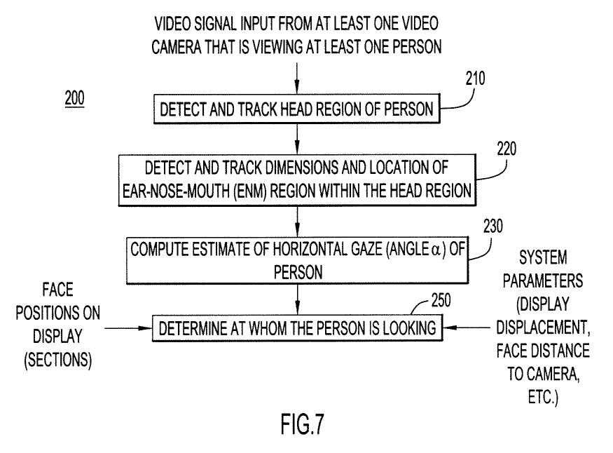

Turning now to FIG. 6, a block diagram of controller 160(1) in endpoint 100(1) is shown, and as explained above, controller 160(2) in endpoint 100(2) is configured in a similar manner to controller 160(1). The controller 160(1) comprises a data processor 162 and a memory 164. The processor 162 may be a microprocessor, digital signal processor or other computing data processor device. The memory 164 stores or is encoded with instructions for horizontal gaze estimation process logic 200 that, when executed by the processor 162, cause the processor 162 to perform a horizontal gaze estimation process described hereinafter. The memory 164 may also be used to store data generated in the course of the horizontal gaze estimation process. Alternatively, the horizontal gaze estimation process logic 200 may be performed by digital logic in a hardware/firmware form, such as with fixed digital logic gates in one or more application specific integrated circuits (ASICs), or programmable digital logic gates, such as in a field programming gate array (FPGA), or any combination thereof.

Turning to FIG. 7, the horizontal gaze estimation process logic 200 is now generally described. The input to the process 200 is a video signal from at least one video camera cluster that is viewing at least one person. The video signal may originate from a local video camera cluster and/or from the video camera cluster at another endpoint. At 210, the head region of the person is detected and tracked from a video signal output from a video camera that views a person. Any of a number of head tracking video signal analysis techniques now known or hereinafter developed may be used for the function 210. Face detection can be done in various ways under different computation requirements, such as based on one or more of color analysis, edge analysis, and temporal difference analysis. Examples of face detection techniques are disclosed in, for example, commonly assigned U.S. Published Patent Application No. 2008/0240237, entitled “Real-Time Face Detection,” published on Oct. 2, 2008 and commonly assigned U.S. Published Patent Application No. 2008/0240571, entitled “Real-Time Face Detection Using Temporal Differences,” published Oct. 2, 2008. The output of the head or face detection function 210 is data for a first (head) rectangle representing the head region of a person, such as the regions 50 and 60 shown in FIGS. 2 and 3, respectively.

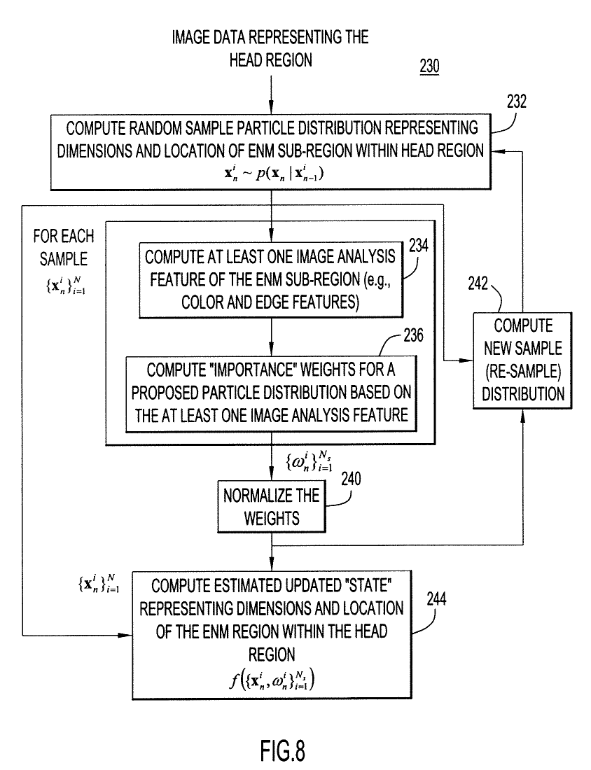

At 220, the ENM sub-region within the head region is detected and its dimensions and location within the head region are tracked. The output of the function 220 is data for dimensions and relative location of an ENM sub-region (rectangle) within the head region (rectangle). Again, examples of the ENM sub-region (e.g., ENM rectangle) are shown at reference numerals 52 and 62 in FIGS. 2 and 3, respectively. One technique for detecting and tracking the dimensions and location of the ENM sub-region within the head region is described hereinafter in conjunction with FIG. 8.

Using data representing the head region and the dimensions and relative location of the ENM sub-region within the head region, an estimate of the horizontal gaze, e.g., gaze angle α, is computed at 230. The computation for the horizontal gaze angle is given and described above with respect to equation (1) for the horizontal gaze of a person with respect to a video camera using the angles as defined in FIG. 1 and the measurements d and r. Data for d and r represent the relative location of the ENM rectangle within the head rectangle.

At 250, a determination is then made as to at whom the person, whose head region and ENM sub-region is being tracked at functions 210 and 220, is looking. In making the determination at 250, other data and system parameter information is used, including face positions on the various display sections (at the local endpoint device and the remote endpoint device(s)), as well as display displacement distance from a video camera cluster to the face of a person (determined or approximated a priori, etc.).

Referring now to FIG. 8, one example of a process for performing the ENM sub-region tracking function 230 is now described. In this example, probabilistic tracking techniques are used, and in particular sequential Monte Carlo methods, also known as particle filter techniques. Similar to Kalman filters, the objective of particle filtering techniques is to estimate the posterior probability distribution of the state of a stochastic system given noisy measurements. Unlike Kalman filters which assume the posterior density at every step is Gaussian, particle filters can propagate more general distributions, albeit only approximately. The required posterior density function is represented by a set of discrete, random samples (particles) with associated “importance” weights and to compute estimates based on these samples and importance weights. In the case of the ENM sub-region tracking, the “state” is data representing the dimensions and location of the ENM sub-region (e.g., ENM rectangle) within the head region. Generally, the function 240 is configured to, at each time step, compute random samples (particles) of the ENM rectangle dimensions and position distributed within the head region. The importance weights of the samples are calculated based on at least one image analysis feature (e.g., color and edge features) with respect to a reference model. The output state is estimated as the weighted average of all the samples or of the first few samples that have the highest importance weights.

As shown in FIG. 8, the input to the function 230 is image data representing the head region (which is the output of function 220 in FIG. 7). At 232, data is computed for a random sample particle distribution representing dimensions and location of the ENM sub-region within the head region, i.e., xₙⁱ˜p(xₙ|xₙ₋₁ⁱ), where xₙεX and X denotes the state space, as time progresses. Again, the state is the ENM rectangle that is to be tracked, which is defined as xₙ=(xₙ, yₙ, wₙ, hₙ) with n denoting the time step, and the state space X is an expanded region of the head rectangle. In one example, it is assumed that the state evolves according to a Gaussian random walk process:

p(xₙ|xₙ₋₁)˜N(xₙ|xₙ₋₁,Λ) (2)

where xₙ₋₁, the state at the previous time step, is the mean and Λ=diag(σₓ², σ_{y}², σ_{w}², σₕ²) is the covariance matrix for the multi-dimensional Gaussian distribution.

For each sample {xₙⁱ}ᵢ₌₁^{N} computed at 232, functions 234 and 236 are performed. Function 234 involves computing at least one image analysis feature of the ENM sub-region and comparing it with respect to a corresponding reference model. At function 236, importance weights are computed for a proposed (new) particle distribution based on the at least one image analysis feature computed at 234.

More specifically, at 234, one or several measurement models, also called a likelihood, is employed to relate the noisy measurements to the state (the ENM rectangle). For example, two sources of measurements (image features) are considered: color, y^{C}, and edge features, y^{E}. More explicitly, the normalized color histograms in the blue chrominance (Cb) and red chrominance (Cr) color domains and the vertical and horizontal projections of edge features are analyzed. To do so, a reference histogram or projection is generated, either offline using manually selected training data or online using a relatively coarse ENM detection scheme, such as those described in the aforementioned published patent applications, for a number of frames and computing a time average.

Denoting a reference histogram or projection as h_{ref} and the histogram or projection for the region corresponding to the state x is hₓ, the likelihood model is defined as

$$p ( {y}^{C} \vert x ) ∝ exp ( - {\sum }_{c ∈ \{ Cb , Cr \}} {D}^{2} ( {h}_{x}^{c} , {h}_{ref}^{c} ) / 2 {σ}_{c}^{2} ) \qquad ( 3 )$$

for color histograms, and

$$p ( {y}^{E} \vert x ) ∝ exp ( - {\sum }_{e ∈ \{ V , H \}} {D}^{2} ( {h}_{x}^{e} , {h}_{ref}^{e} ) / 2 {σ}_{e}^{2} ) \qquad ( 4 )$$

for edge feature projections, where D(h₁, h₀) is the Bhattacharyya similarity distance, defined as

$$D ( {h}_{1} , {h}_{0} ) = {( 1 - {\sum }_{i = 1}^{B} \sqrt{{h}_{i , 1} {h}_{i , 0}} )}^{1 / 2} \qquad ( 5 )$$

with B denoting the number of bins of the histogram or the projection.

At 236, the proposed distribution of new samples is computed. While the choice of the proposal distribution is important for the performance of the particle filter, one technique is to choose the proposed distribution as the state evolution model p(xₙ|xₙ₋₁). In this case, the particles, {xₙⁱ}ᵢ₌₁^{N}^{ₛ} at time step n, where Nₛ, is the number of particles, are generated following p(xₙ|xₙ₋₁), and the importance weights, {ωₙⁱ}ₙ₋₁^{N}^{ₛ}, are computed so as to be proportional to the joint likelihood of color and edge features, i.e.,

ωₙⁱ∝ωₙ₋₁ⁱp(y^{C}|xₙⁱ)p(y^{E}|xₙⁱ). (6)

At 240, the weights are normalized such that

$${\sum }_{i = 1}^{{N}_{s}} {ω}_{n}^{i} = 1.$$

At 242, a re-sampling function is performed at each time step to compute a new (re-sample) distribution by multiplying particles with high importance weights and discarding or de-emphasizing particles with low importance weights, while preserving the same number of samples. Without re-sampling, a degeneracy phenomenon may occur, where the concentration of most of the weight on a single particle may occur that dramatically degrades the sample-based approximation of the filtering distribution.

At 244, an updated state representing the dimensions and location of the ENM sub-region within the head region, f({xₙⁱ, ωₙⁱ}ᵢ₌₁^{N}^{ₛ}), is computed. The output at each time step, that is, the location and dimensions of the ENM rectangle, is the expectation of xₙ. In other words, the output is the weighted average of the particles,

$${\sum }_{i = 1}^{{N}_{s}} {ω}_{n}^{i} {x}_{n}^{i} ,$$

or the weighted average of the first few particles that have the highest importance weights. The updated state may be computed at 244 after determining that the state is stable. For example, the state may be said to be stable when it is determined that the weighted mean square error of the particles, varₙ, as denoted in equation (7) below, is less than a predetermined threshold value for at least one video frame. There are other ways to determine that the state is stable, and in some applications, it may be desirable to compute an update to the state even if it is not stable.

$${var}_{n} = {\sum }_{i = 1}^{{N}_{S}} {{ω}_{n}^{i} ( {x}_{n}^{i} - {\overline{x}}_{n} )}^{2} , where {\overline{x}}_{n} = {\sum }_{i = 1}^{{N}_{s}} {ω}_{n}^{i} {x}_{n}^{i} . \qquad ( 7 )$$

The particle filtering method to determine the dimensions and location of the ENM sub-region within the head region can be summarized as follows.

With {xₙ₋₁ⁱ, ωₙ₋₁ⁱ}ᵢ₌₁^{N}^{ₛ} the particle set at the previous time, proceed as follows at time n:

FOR i=1:Nₛ
Distribute new particles: xₙⁱ˜p(xₙ|xₙ₋₁ⁱ)
Assign the particle a weight, ωₙⁱ, according to equation (6)

END FOR

Normalize weights {ωₙⁱ}ᵢ₌₁^{N}^{ₛ} such that

$${\sum }_{i = 1}^{{N}_{s}} {ω}_{n}^{i} = 1$$

Re-sample.

The horizontal gaze analysis techniques described herein provide gaze awareness of multiple conference participants in a video conferencing session. These techniques are useful in developing value added features that are based on a better understanding of an ongoing telepresence video conferencing session. The techniques can be executed in real-time and do not require special hardware or accurate eyeball location determination of a person.

There are many uses for the horizontal gaze analysis techniques described herein. One use is to find a “common view” of a group of participants. For example, if a first person is speaking, but several other persons are seen to change their gaze to look at a second person's reaction (even though the second person may not be speaking at that time), the video signal from the video camera cluster can be selected (i.e., cut) to show the second person. Thus, a common view can be determined while displaying video images of each of a plurality of persons on corresponding ones of a plurality of video display sections, by determining towards which of the plurality of persons a given person is looking from the estimate of the horizontal gaze of the given person. Another related application is to display the speaking person's video image on one screen (or on one-half of a display section by cropping the picture) and the person at whom the speaking person is looking on an adjacent screen (or the other half of the same display section). In these scenarios, the gaze or common view information is used as input to the video switching algorithm.

The way to handle the situation of people looking in different directions depends on the application. In the video switching examples, the conflict could be resolved by giving a preference to the “common view” or the active speaker, or other pre-defined means of a “more important” person based on the context of the meeting.

Still another application is to fix eye gaze caused by moving eyeballs. The horizontal gaze analysis techniques described herein can be used to determine that a person's gaze is not “correct” because the person is looking at a display screen or section but is being captured by a video camera that is not above the display screen or section. Under these circumstances, processing of the video signal for that person can be artificially compensated to “move” or adjust that person's eyeball direction so that it appears as if he/she were looking in the correct direction.

Yet another application is to fix eye gaze by switching video cameras. Instead of artificially moving the eyeballs of a person, a determination is made from the horizontal gaze of the person as to which display screen or section he/she is looking at, and a video signal from one of a plurality of video cameras is selected, e.g., the video camera co-located with that display screen or section for viewing that person.

Still another use is for massive reference memory indexing. Massive reference memory may be exploited to improve prediction-based video compression by providing a well matching prediction reference. Applying the horizontal gaze analysis techniques described herein can facilitate the process of finding the matching reference. In searching through massive memory, for example, it might be that frames that have similar eye gaze (and head positions) provide good matches and can be considered as a candidate of prediction reference to improve video compression. Further search can then be focused on such candidate frames to find the best matching prediction reference, hence accelerating the process.

Although the apparatus, system, and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following claims.

What is claimed is:

1. A method comprising:
viewing at least a first person with at least a first video camera and producing a video signal therefrom;
detecting and tracking a head region of the first person in the video signal;
detecting and tracking dimensions and location of a sub-region within the head region in the video signal; and
computing an estimate of a horizontal gaze of the first person from a relative position of the sub-region within the head region.

2. The method of claim 1, wherein viewing comprises viewing the first person with the first video camera that is positioned with respect to a plurality of video display sections arranged to face the first person, and further comprising displaying video images of each of a plurality of persons on corresponding ones of the plurality of video display sections; and determining towards which of the plurality of persons the first person is looking from the estimate of the horizontal gaze of the first person.

3. The method of claim 1, wherein viewing further comprises viewing a plurality of persons with the first video camera or another video camera, and further comprising determining towards which of the plurality of other persons the first person is looking from the estimate of the horizontal gaze of the first person.

4. The method of claim 1, wherein detecting and tracking the head region comprises generating data for a first rectangle that represents the head region of the first person, and wherein detecting and tracking the sub-region comprises generating data for dimensions and location of a second rectangle within the first rectangle, wherein the second rectangle comprises ears, nose and mouth of the first person.

5. The method of claim 4, wherein computing the estimate of the horizontal gaze comprising computing a distance d between horizontal centers of the first rectangle and the second rectangles, respectively, and a radius r of the first rectangle, and computing a horizontal gaze angle as arcsin(d/r).

6. The method of claim 1, wherein viewing comprises viewing at a first location a first group of persons that includes the first person with the first video camera and viewing at a second location a second group of persons with at least a second video camera, and further comprising displaying at the first location video images on respective video display sections of individual persons in the second group of persons based on a video signal output by the second video camera, and displaying at the second location video images on respective video display sections of individuals persons in the first group of persons based on the video signal output by the first video camera.

7. The method of claim 6, wherein computing comprises computing the estimate of the horizontal gaze of the first person with respect to another person in the first group of persons.

8. The method of claim 6, wherein computing comprises computing the estimate of the horizontal gaze of the first person with respect to a video display section showing a video image of a person in the second group of persons.

9. The method of claim 1, wherein computing comprises, at each time step: computing a random sample particle distribution that represents the dimensions and location of the sub-region within the head region; computing at least one image analysis feature of the sub-region; computing importance weights for a proposed particle distribution based on the at least one image analysis feature; computing a new sample particle distribution by emphasizing components of the sample particle distribution with high importance weights and de-emphasizing components of the sample particle distribution with low importance weights.

10. The method of claim 9, and further comprising computing an updated estimate of the dimensions and location of the sub-region within the head region as a weighted average of the new sample particle distribution.

11. The method of claim 9, and further comprising computing an updated estimate of the dimensions and locations of the sub-region within the head region based on a weighted average of components of the new sample particle distribution that have highest importance weights.

12. The method of claim 1, wherein detecting the head region, detecting the sub-region and computing are performed with respect to each of a plurality of persons so as to compute a common view from the horizontal gaze of each of the plurality of persons, and further comprising selecting a video signal containing an image of a particular person towards whom the common view is determined.

13. The method of claim 1, wherein detecting the head region, detecting the sub-region and computing are performed with respect to each of a plurality of persons so as to compute a common view from the horizontal gaze of each of the plurality of persons, and further comprising displaying a speaking person's image on one section of a display and displaying in another section of the display an image of a person towards whom the common view is determined.

14. The method of claim 1, and further comprising processing a video image of the first person to artificially adjust eyeball direction of the first person.

15. The method of claim 1, and further comprising selecting for output to a display a signal from one of a plurality of video cameras based on the horizontal gaze of the first person.

16. Logic encoded in one or more tangible media for execution and when executed operable to:
detect and track a head region of a person from a video signal produced by a video camera that is configured to view a person;
detect and track dimensions and location of a sub-region within the head region in the video signal; and
compute an estimate of a horizontal gaze of the person from a relative position of the sub-region within the head region.

17. The logic of claim 16, wherein the logic that detects and tracks the head region comprises logic that is configured to generate data for a first rectangle that represents the head region of the person, and the logic that detects and tracks the sub-region comprises logic that is configured to generate data for dimensions and location of a second rectangle within the first rectangle, wherein the second rectangle comprises ears, nose and mouth of the person.

18. The logic of claim 17, wherein the logic that computes the estimate of the horizontal gaze comprises logic that is configured to compute a distance d between horizontal centers of the first rectangle and the second rectangles, respectively, and a radius r of the first rectangle, and to compute a horizontal gaze angle as arcsin(d/r).

19. The logic of claim 16, wherein the logic that computes the estimate of the horizontal gaze comprises logic that is configured to, at each time step: compute a random sample particle distribution that represents the dimensions and location of the sub-region within the head region; computes at least one image analysis feature of the sub-region; computes importance weights for a proposed particle distribution based on the at least one image analysis feature; computes a new sample particle distribution by emphasizing components of the sample particle distribution with high importance weights and de-emphasizing components of the sample particle distribution with low importance weights.

20. An apparatus comprising:
at least one video camera that is configured to view a person and to produce a video signal;
a processor that is configured to:
detect and track a head region of the person in the video signal;
detect and track dimensions and location of a sub-region within the head region in the video signal; and
compute an estimate of a horizontal gaze of the person from a relative position of the sub-region within the head region.

21. The apparatus of claim 20, wherein the processor is configured to detect and track the head region by generating data for a first rectangle that represents the head region of the person, and the processor is configured to detect and track the sub-region by generating data for dimensions and location of a second rectangle within the first rectangle, wherein the second rectangle comprises ears, nose and mouth of the person.

22. The apparatus of claim 21, wherein the processor is configured to compute the estimate of the horizontal gaze by computing a distance d between horizontal centers of the first rectangle and second rectangles, respectively, and a radius r of the first rectangle, and computing a horizontal gaze angle as arcsin(d/r).
